(19) United States
(12) Patent Application Publication
(10) Pub. No.: US 2014/0137910 A1
(43) Pub. Date: May 22, 2014

(54) DRY ICE BLASTING CLEANING SYSTEM AND METHOD OF USING THE SAME

(71) Applicant: BRATNEY COMPANIES, Des Moines, IA (US)

(72) Inventors: Thomas R. JOHNSTON, Altoona, IA (US); Curt Mathew DAVIS, Ankeny, IA (US)

(73) Assignee: BRATNEY COMPANIES, Des Moines, IA (US)

(21) Appl. No.: 13/681,905

(22) Filed: Nov. 20, 2012

(51) Int. Cl. B08B 5/02

(52) U.S. Cl. CPC B08B 5/02
USPC 134/198

(57) ABSTRACT

A cleaning system having at least one C0₂ blasting nozzle connected to a robotic arm to automatically and selectively clean an object transported on an assembly line.

### BACKGROUND OF THE INVENTION

This invention is directed toward a dry ice blasting cleaning system, and more particularly a cleaning system that utilizes a robotic arm to clean a device being transported on an assembly line.

Cleaning systems are well-known in the art. As an example, in the bulk-seed industry, tote boxes are cleaned manually with water using a high pressure nozzle. While effective in cleaning the box, the process is time consuming, labor intensive, and requires additional time for the boxes to dry. In addition, because the boxes sometimes contain chemicals, the water needs to be filtered and/or treated before disposal or further use.

Other cleaning systems have utilized C0₂ (or dry ice) blasting equipment. Typically, this equipment is operated manually or through use of a robotic device designed to clean a specific object. These devices are complex, expensive to manufacture, and have limited use. Accordingly, there is a need in the art for a system that addresses these deficiencies.

Accordingly, an objective of the present invention is to provide a cleaning system that is easier to use.

Another objective of the present invention is to provide a cleaning system that is more efficient.

A still further objective of the present invention is to provide a cleaning system that automatically cleans objects transported on an assembly line.

These and other objectives will be apparent to one skilled in the art based upon the following written description, drawings, and claims.

### SUMMARY OF THE INVENTION

A cleaning system having an assembly line that transports a device to be cleaned. A robot, positioned adjacent the assembly line has an arm controlled by a controller. At least one nozzle, associated with C0₂ blasting equipment, is connected to the arm of the robot. The controller has a display with a grid that permits an operator to select a section of the grid to repeat the cleaning of the object.

### BRIEF DESCRIPTION OF THE DRAWINGS

FIG. 1 is an end view of a cleaning system;

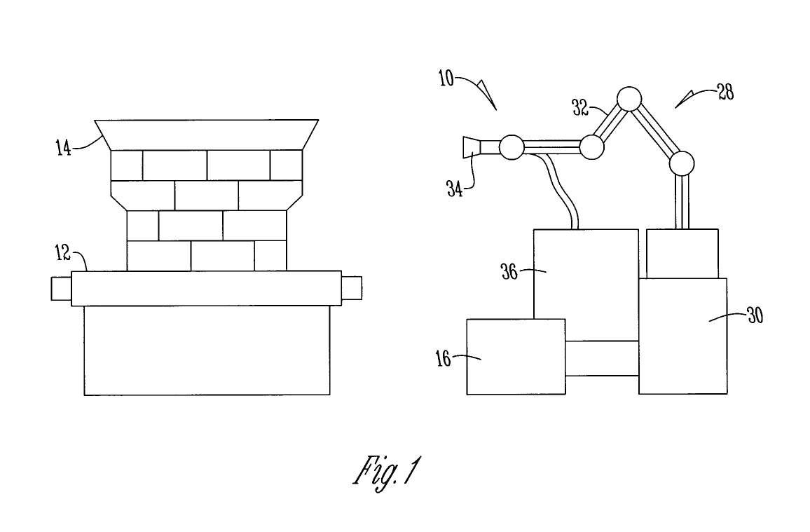

FIG. 2 is a top plan view of a cleaning system;

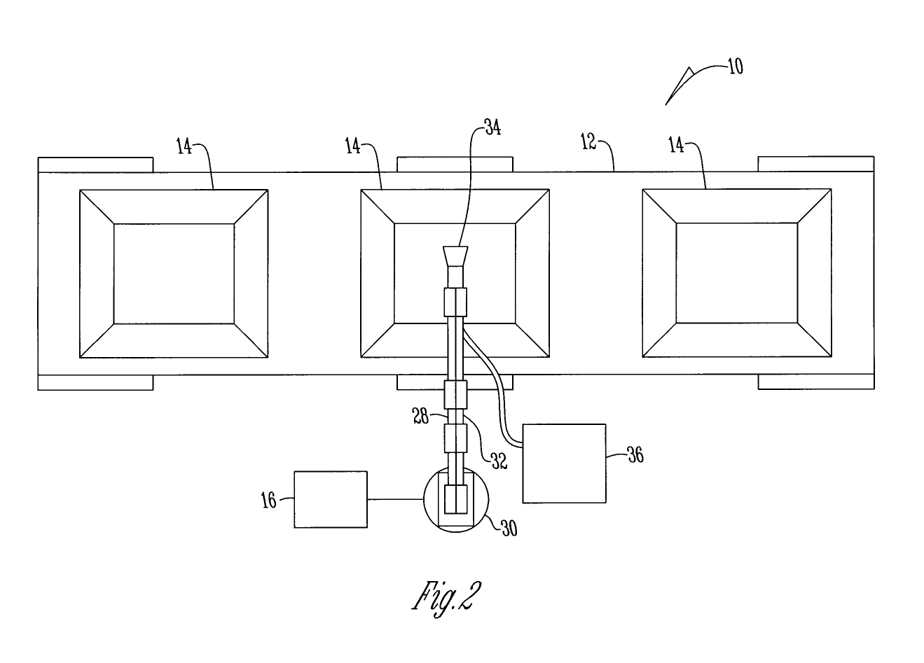

FIG. 3 is a top plan view of a cleaning system; and

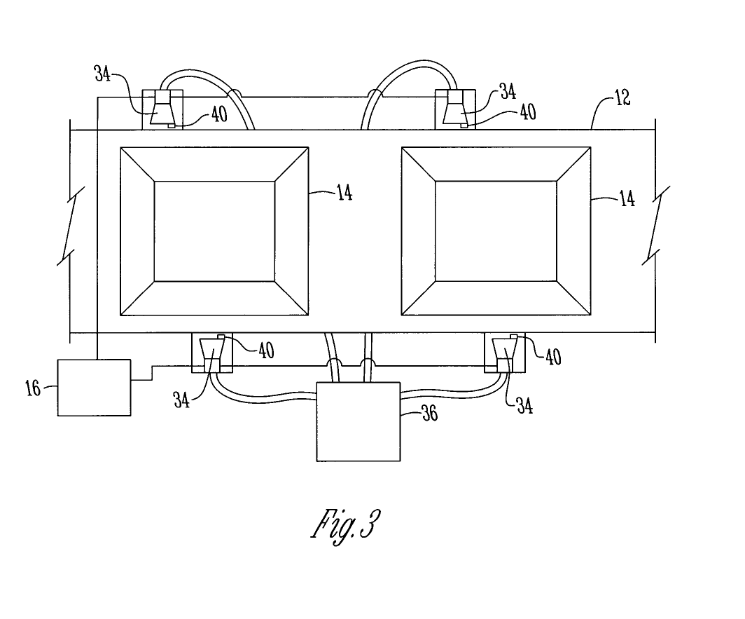

FIG. 4 is a schematic drawing of a cleaning system.

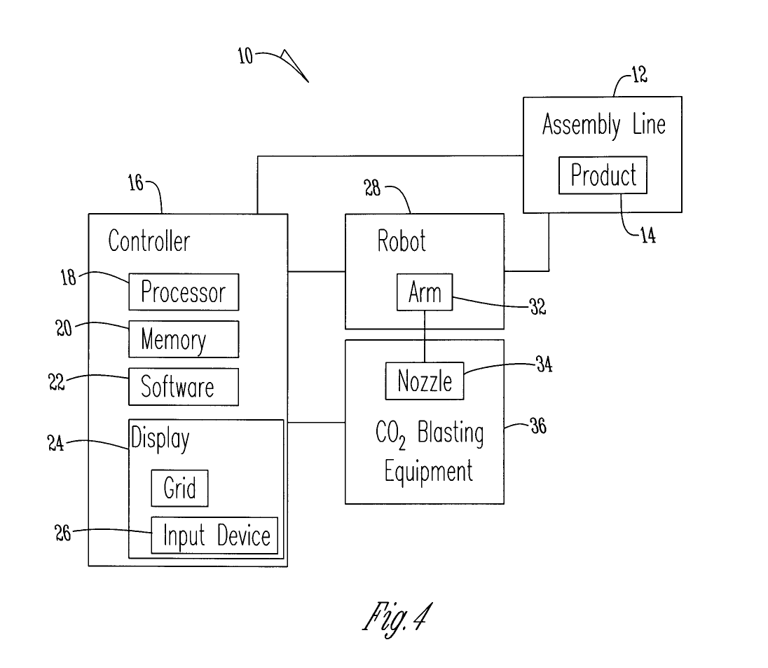

### DETAILED DESCRIPTION OF THE PREFERRED EMBODIMENTS

Referring to the Figures, the system 10 includes an assembly line 12 for transporting a product or device 14 to be cleaned. By example only, the device shown is a bulk seed tote box used for transporting seed. Other products and devices 14 may be used without departing from the invention.

The assembly line 12 is of any size or shape and preferably advancement of the device 14 along the assembly line 12 is operated by a controller 16. The controller includes a processor 18, a memory 20, software 22, a display 24, and an input device 26.

Positioned adjacent the assembly line 1 is a robot 28. The robot has a base 30 and an arm 32. Connected to the arm 32 is one or more nozzles 34 which are associated with C0₂ blasting equipment 36 for blasting granules of dry ice.

In operation, prior to loading a device 14 on the assembly line 12, the controller 16 is programmed to control the operation of the assembly line 12, the robot 28, and the C0₂ blasting equipment 36. More specifically, the controller is programmed to activate the arm 32 of the robot 28 to clean the inside and/or outside of the device 16. In this manner, sections of the device 16 are separated into a grid 38 which is shown on the display 24 of the controller 16. The controller is programmed to activate the C0₂ equipment 36 and to mimic the cleaning operation of the arm 32 of the robot when the product is in a stationary position or at different transport speeds as the device 16 moves along the assembly line 12.

Once programmed, a device 14 is loaded on to the assembly line 12 and transported to a cleaning zone. Once the cleaning zone is reached, the robot 28 and C0₂ equipment 36 are activated and the arm 32 of the robot 28 proceeds to move along the contour of the device 14 as dry ice is blasted from the nozzle 34 of the C0₂ blasting equipment 36.

Upon observation, if there is an area of the device that requires further cleaning, an operator selects the desired section of the grid 38 on the display 24 and the movement of the arm 32 of the robot 28 is repeated. Once cleaned, the device 14 travels further down the assembly-line 12 and is unloaded.

In an alternative embodiment a plurality of nozzles 34 associated with the C0₂ blasting equipment 36 are mounted in stationary positions along the assembly line 12. Preferably, each nozzle is positioned to clean a different section of the device 14 placed on the assembly line 12. The nozzles 34 have sensors 40 that detect the presence of the device 14 as it passes by on the assembly line 12. Should additional cleaning in an area be desired, an operator may stop or slow the assembly line in front of a desired nozzle or reverse the assembly line and repeat the movement in front of the desired nozzle 34.

Accordingly, a cleaning system has been disclosed that at the very least meets all of the stated objectives.

What is claimed is:

1. A cleaning system, comprising:
an assembly line designed for receiving and transporting a device;
a robot positioned adjacent the assembly line and having a base and an arm;
at least one nozzle connected to the arm and associated with C0₂ blasting equipment; and
a controller connected to the assembly line, the robot, and the C0₂ blasting equipment for operating the same.

2. The system of claim 1 wherein the controller has a display where sections of the device are separated into a grid shown on the display.

3. The system of claim 2 wherein the operation of the arm of the robot is repeated by selecting a desired section on the grid.

4. A method of cleaning a device comprising the steps of:
placing a device on an assembly line;
transporting the device to a cleaning zone;
activating an arm of a robot programmed to clean the contour of the device and a nozzle to blast dry ice from C0₂ blasting equipment;
transporting the device on the assembly line past the cleaning zone; and
unloading the device.

5. The method of claim 4 further comprising the step of repeating the cleaning of a section of the device by selecting a desired section of a grid shown on a display of a controller.

6. A system for cleaning, comprising:
an assembly line designed for receiving and transporting a device; and
a plurality of nozzles associated with C0₂ blasting equipment positioned along the assembly line for cleaning sections of the device.

7. The system of claim 6 wherein the assembly line is stopped adjacent selected nozzles for additional cleaning.

8. The system of claim 6 wherein the assembly line is slowed as it passes a selected nozzle for additional cleaning.

9. The system of claim 6 wherein the assembly line is reversed to repeat cleaning in front of a selected nozzle.

10. The system of claim 6 where the nozzles have sensors that detect the presence of the device.
